(19) United States
(12) Patent Application Publication
(10) Pub. No.: US 2015/0040059 A1
(43) Pub. Date: Feb. 5, 2015

(54) SYSTEM, DEVICE, AND METHOD FOR SCROLLING CONTENT WITH MOTION BLUR ON AN ELECTRONIC DISPLAY

(71) Applicant: Intel Corporation, Santa Clara, CA (US)

(72) Inventor: Kaining Yuan, Shanghai (CN)

(73) Assignee: INTEL CORPORATION, Santa Clara, CA (US)

(21) Appl. No.: 13/977,307

(22) PCT Filed: Jun. 26, 2012
(86) PCT No.: PCT/CN2012/077524

§ 371 Date: Sep. 20, 2013

(51) Int. Cl. G06F 3/0485; G06T 13/80

(52) U.S. Cl. CPC G06F 3/0485; G06T 13/80
USPC 715/784

(57) ABSTRACT

A device, method, and system for scrolling content with motion blur on an electronic monitor or display. In response to detection of scrolling through displayable content using at least one scrolling device, a motion blurred animation of movement of the displayable content resulting from operation of the at least one scrolling device is generated and displayed based on scroll direction and at least one of scroll distance and scroll speed.

### BACKGROUND

Content scrolling on electronic monitors and displays is commonplace, and is typically provided for navigating through content that is too large or voluminous to be practically displayed simultaneously on a single monitor or display. Conventional content scrolling devices and controls are widely implemented in computer and computer-controlled systems of many different types including myriad fixed position and mobile implementations.

Content scrolling systems may be implemented using one or more peripheral scrolling or scroll-enabled devices and/or using conventional touchscreen technology. When content is being scrolled, conventional scrolling processes typically control the display or monitor to display a visual animation of moving content with a high degree of content clarity and definition. Content that may be scrolled may include one or any combination of text, photographs, computer-generated icons or other displayed images, displayed images depicting files or other data structures, and/or other computer-generated graphic information.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of at least one embodiment of a computing device for scrolling content with motion blur on a display of the computing device;

FIG. 2 is an illustrative example of at least one embodiment of displayable content that may be displayed on the display of the computing device illustrated in FIG. 1 during operation;

FIG. 3 is an illustrative example of the display of the computing device illustrated in FIG. 1 shown in the process of scrolling the displayable content of FIG. 2 with motion blur;

FIG. 4 is a simplified block diagram of at least one embodiment an environment established by the computing device illustrated in FIG. 1 during operation;

FIG. 5 is an illustrative example of one portion of content displayed on a display of computing device illustrated in FIG. 1;

FIG. 6 is an illustrative example of another portion of content of FIG. 5 displayed on the display of the computing device illustrated in FIG. 1;

FIGS. 7 and 8 are simplified flow diagrams of at least one embodiment of a method for scrolling content with motion blur that may be executed by the computing device illustrated in FIG. 1; and

FIG. 9 is an illustrative example of the display of the computing device illustrated in FIG. 1 shown in the process of scrolling through the content of FIGS. 5 and 6 with motion blur implemented in the display of the scrolling content.

### DETAILED DESCRIPTION OF THE DRAWINGS

While the concepts of the present disclosure are susceptible to various modifications and alternative forms, specific embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated by one skilled in the art, however, that embodiments of the disclosure may be practiced without such specific details. In other instances, control structures, gate level circuits and full software instruction sequences have not been shown in detail in order not to obscure the description of the of the concepts described herein. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the concepts described herein may be implemented in hardware, firmware, software, or any combination thereof. Embodiments implemented in a computer system may include one or more point-to-point or bus-based interconnects between components. Embodiments of the concepts described herein may also be implemented as instructions carried by or stored on one or more machine-readable or computer-readable storage media, which may be read and executed by one or more processors. A machine-readable or computer-readable storage medium may be embodied as any device, mechanism, or physical structure for storing or transmitting information in a form readable by a machine (e.g., a computing device). For example, a machine-readable or computer-readable storage medium may be embodied as read only memory (ROM) device(s); random access memory (RAM) device(s); magnetic disk storage media; optical storage media; flash memory devices; mini- or micro-SD cards, memory sticks, and others.

In the drawings, specific arrangements or orderings of schematic elements, such as those representing devices, modules, instruction blocks and data elements, may be shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

In general, schematic element used to represent instruction blocks may be implemented using any suitable form of machine-readable instruction, such as software or firmware applications, programs, functions, modules, routines, processes, procedures, plug-ins, applets, widgets, code fragments and/or others, and that each such instruction may be implemented using any suitable programming language, library, application programming interface (API), and/or other software development tools. For example, some embodiments may be implemented using Java, C++, and/or other programming languages. Similarly, schematic elements used to represent data or information may be implemented using any suitable electronic arrangement or structure, such as a register, data store, table, record, array, index, hash, map, tree, list, graph, file (of any file type), folder, directory, database, and/or others.

Further, in the drawings, where connecting elements, such as solid or dashed lines or arrows, are used to illustrate a connection, relationship or association between or among two or more other schematic elements, the absence of any such connecting elements is not meant to imply that no connection, relationship or association can exist. In other words, some connections, relationships or associations between elements may not be shown in the drawings so as not to obscure the disclosure. In addition, for ease of illustration, a single connecting element may be used to represent multiple connections, relationships or associations between elements. For example, where a connecting element represents a communication of signals, data or instructions, it should be understood by those skilled in the art that such element may represent one or multiple signal paths (e.g., a bus), as may be needed, to effect the communication.

Human perception of an object moving within a field of view is generally understood to be limited in that the human vision and vision processing system can take in and process only a limited amount of visual information about the object. For example, in certain velocity ranges; e.g., one human walking past another at a normal walking pace of 5 kilometers per hour, humans can generally “see” a moving object relative to its environment with a high degree of visual clarity and definition. However, as the velocity of the moving object increases, a human's ability to clearly and distinctly track the object moving through its environment diminishes. For example, at sufficiently high speeds, e.g., a bullet fired from a gun at 900 meters per second, the human vision and vision processing system cannot track the moving object at all relative to its environment, and at such speeds the moving object therefore appears to humans to be invisible. In lesser speed ranges, e.g., a baseball moving at 50 meters per second, a moving object can be perceived by the human vision and vision processing system, although the object appears to have less clarity and definition than the environment, in which is it is moving. An object moving in such a velocity range in which it appears less defined, distinct, precise or clear relative to the environment in which it is moving is typically referred to as being “blurred in the direction of its motion,” and the amount or degree of perceived blurring of an object is directly proportional to velocity with which it is moving.

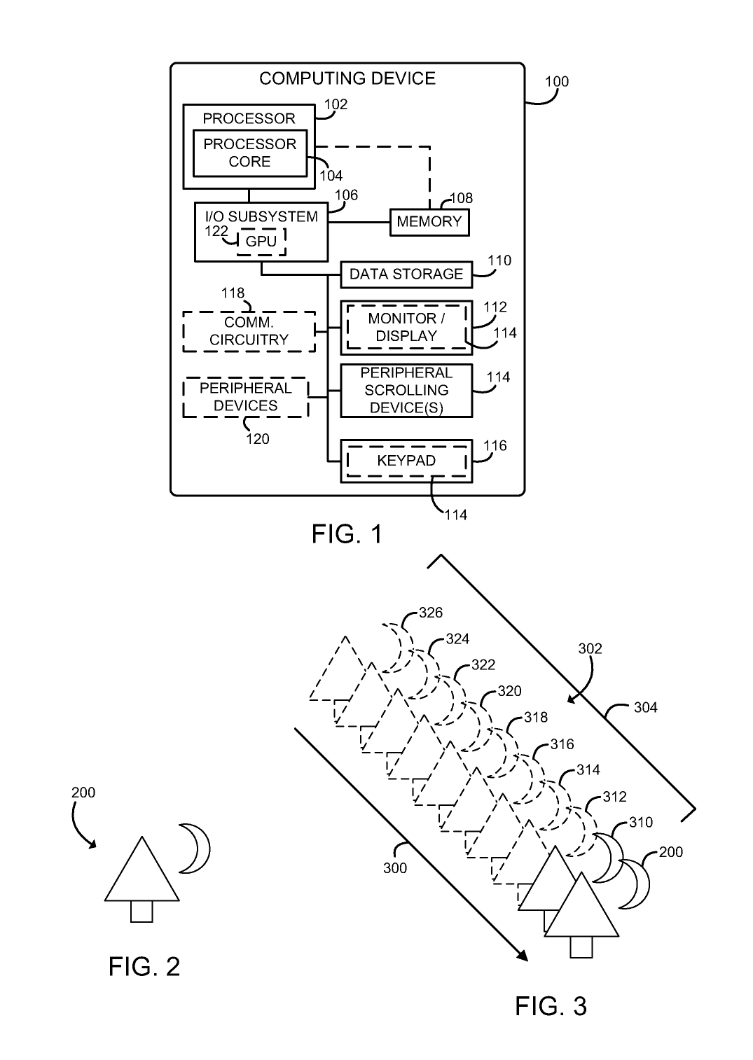

In the context of content scrolling on a visual monitor or display of an electronic device or system, moving content can advantageously be made to appear smoother and/or more predictable, and therefore more natural to human perception, by implementing motion blur technology in otherwise conventional content scrolling systems. Referring now to FIG. 1, a simplified block diagram is shown of an embodiment of one such computing system or device 100 in which scrolling content on a monitor or display 112 is implemented with motion blur. Illustratively, the amount or degree of motion blur is determined as a function of scroll velocity, and is applied to the changing images, e.g., updated frames, during scrolling in a manner that blurs the images, e.g., frames, in the direction of scrolling motion to thereby simulate, during content scrolling, the natural way in which humans perceive moving objects.

The computing device 100 may be embodied as any electronic device or system capable of displaying content which may be scrolled, and which includes a scrolling or scroll-enabled device and/or conventional scroll-enabled touchscreen technology. Scrolling in the computing device 100 may be implemented vertically, i.e., from the top of the monitor or display 112 toward the bottom or visa versa, and/or horizontally, i.e., from one side of the monitor or display 112 toward the other. Examples of the computing device 100 include, for example, but are not limited to, desktop, laptop, notebook or tablet computers, audio and/or video recording and/or playback devices or systems, subscription television devices or systems, electronic gaining devices or systems, entertainment and/or driver information devices or systems in motor vehicles, indoor and/or outdoor sports equipment devices or systems, or the like, and any of myriad handheld electronic devices. Examples of such handheld electronic devices may include, but should not be limited to, cellular telephones, smart phones, mobile internet devices (MID), personal digital assistants (PDA), audio and/or video recording and/or playback devices, navigation devices, and the like.

In the illustrative embodied of FIG. 1, the computing device 100 includes a processor 102, an I/O subsystem 106, a memory 108, a data storage 110, a monitor or display 112, one or more peripheral scrolling devices 114, and a keypad 116. In some embodiments, several of the foregoing components may be incorporated on a motherboard or main board of the computing device 100, while other components may be communicatively coupled to the motherboard via, for example, a peripheral port. Furthermore, it should be appreciated that the computing device 100 may include other components, sub-components, and devices commonly found in a mobile computing device, which are not illustrated in FIG. 1 for clarity of the description.

The processor 102 may be embodied as any type of processor, microprocessor, microcontroller, digital signal processor, or other processing circuitry including the features and capabilities described herein. The processor 102 is illustratively embodied as a single core processor having a processor core 104. However, in other embodiments, the processor 102 may be embodied as a multi-core processor having multiple processor cores 104. Additionally, in some embodiments, the processor 102 may include additional processors 102, or other processors, having one or more processor cores.

The I/O subsystem 106 of the computing device 100 may be embodied as circuitry and/or components to facilitate input/output operations with the processor 102 and/or other components of the computing device 100. In some embodiments, the I/O subsystem 106 may be embodied as a memory controller hub (MCH or “northbridge”), an input/output controller hub (ICH or “southbridge”), and a firmware device. In other embodiments, however, I/O subsystems having other configurations may be used. For example, in some embodiments, the I/O subsystem 106 may be embodied as a platform controller hub (PCH). In such embodiments, the processor 102 may communicate directly with the memory 108 (as shown by the hashed line in FIG. 1). Additionally, in other embodiments, the I/O subsystem 106 may form a portion of a system-on-a-chip (Sol′) and be incorporated, along with the processor 102 and other components of the computing device 100, on a single integrated circuit chip.

In some embodiments, the I/O subsystem 106 may include a graphics processing unit 122, which may be embodied as a separate processor dedicated to the processing of display content. Alternatively, the graphics processing unit 122 may be embodied as a separate peripheral card (i.e., a graphics card) communicatively coupled to the I/O subsystem 106. In embodiments in which the computing device 100 includes the graphics processing unit 122, the processing of display content, including the control of the scrolling of such content as discussed below, may be conducted by the graphics processing unit 122 in place of, or in addition to, the processor 102.

The processor 102 is communicatively coupled to the I/O subsystem 106 via a number of signal paths. These signal paths (and other signal paths illustrated in FIG. 1) may be embodied as any type of signal paths capable of facilitating communication between the components of the computing device 100. For example, the signal paths may be embodied as any number of point-to-point links, wires, cables, light guides, printed circuit board traces, vias, bus, intervening devices, and/or the like.

The memory 108 of the computing device 100 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 108 is communicatively coupled to the I/O subsystem 106 via a number of signal paths (or to the processor 102). Although only a single memory device 108 is illustrated in FIG. 1, the computing device 100 may include additional memory devices in other embodiments. Various data and software may be stored in the memory 108. For example, one or more operating systems, applications, programs, libraries, and drivers that make up the software stack executed by the processor 102 may reside in memory 108 during execution.

The data storage 110 may be embodied as any type of device or devices configured for the short-term or long-term storage of data including, but not limited to additional memory devices and circuits, memory cards, hard disk drives, solid-state drives, or other data storage devices. The computing device 100 may store, access, and/or maintain various data in the data storage 110.

The monitor or display 112 may be embodied as any type of monitor or display capable of displaying content to a user of the computing device 100. For example, the display 112 may be embodied as a liquid crystal display (LCD), cathode ray tube (CRT) display, a light-emitting diode display (LED), a plasma display panel (PDP), an electroluminescent display, or other type of display device. The display 112 may be integral to the main housing of the computing device 100 (e.g., a display of a smart phone or tablet computer) or may be separate therefrom but coupled thereto (e.g., a monitor operatively coupled to a desktop computer).

The one or more scrolling devices 114 may be embodied as any type of peripheral or integrated device operable by a user of the computing device to scroll content displayed on the display 112. For example, the scrolling device(s) 114 may include, but is not limited to, a convention mouse, trackball, touch pad, scrolling wheel, stylus, keypad keys, and/or other scrolling devices. Alternatively or additionally, the scrolling device 114 may be integrated into the display 112. In such embodiments, the display 112 is embodied as a touch-screen display, which may be implemented using any suitable touch-screen technology including, but not limited to, capacitive touch-screens, resistive touch-screens, surface acoustic wave touch-screens, and/or other touch-screen technologies. As such, the scrolling device(s) 114 may be embodied as any input device through which a user may scroll content displayed on the display 112.

The keypad 116 may be embodied as any type of input device usable by a user of the computing device 100 to enter data into the computing device 110. For example, the keypad 116 may be embodied as a typical alphanumerical keypad or keyboard, or a subset thereof. Additionally, the keypad 116 may be integral to the main housing of the computing device 100 (e.g., a keypad of a smart phone or tablet computer) or may be separate therefrom but coupled thereto (e.g., a keyboard operatively coupled to a desktop computer). As discussed above, one or more individual keys, or combination of keys, may embody one or more of the scrolling devices 114 in some embodiments (e.g., an up arrow key, a down arrow key, a left arrow key, a right arrow key, etc.).

As discussed above, the computing device 100 may be embodied as a communication device, or otherwise include such functionality. In such embodiments, the computing device 100 may include communication circuitry 118 to facilitate such communications. The communication circuitry 118 of the computing device 100 may include any number of devices and circuitry for enabling communications between the computing device 100 and other communication or electronic devices. To do so, the communication circuitry 118 may be configured to use any one or more, or combination thereof, communication such as, for example, a wired network communication protocol (e.g., TCP/IP), a wireless network communication protocol (e.g., Wi-Fi®, WiMAX), a cellular communication protocol (e.g., Wideband Code Division Multiple Access (W-CDMA)), and/or other communication protocols.

In some embodiments, the computing device 100 may include one or more additional peripheral devices 120. Such peripheral devices 128 may include any number of additional input/output devices, interface devices, and/or other peripheral devices. Additionally, the computing device 100 may include additional circuitry and/or components typically found in computing devices, which have not been illustrated in FIG. 1 for clarity of the disclosure.

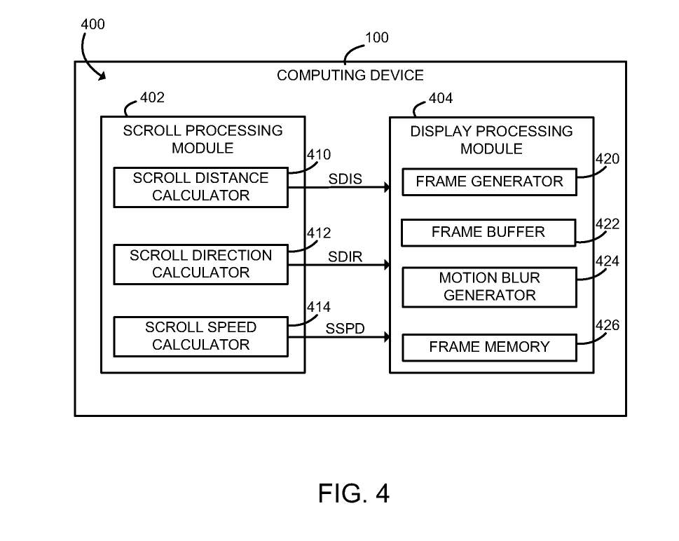

In use, the processor 102 and/or graphics processing unit 122 is configured to control the scrolling of content displayed on the display 112. To do so, as discussed in more detail below, a user of the computing device 100 may operate the scrolling device(s) 114 to scroll content on the display 112 with motion blur. The motion blur of the displayed content may be generated using in any suitable methodology. For example, as shown in FIGS. 2 and 3, a displayable content 200, such as an image or text, may be blurred along the direction of motion 300 as shown in FIG. 3. To do so, in one embodiment, multiple frames of the original image 200 are buffered and displayed contemporaneously with each other along the direction of motion 300. The blurred content produces a tail 302 formed from the multiple frames of the original image 200 having a tail length 304 produced by the display of the multiple frames of the original image 200. In the illustrative embodiment of FIG. 3, nine “historic” frames 310-326 are displayed contemporaneously with the original image 200 to generate the tail 302. In some embodiments, the historic frames located in the center of the tail 302 (e.g., frames 314-322) may be displayed at a greater intensity, brightness, contrast, or transparency relative to those frames located at the beginning and end of the tail 302 (e.g., frames 200 and 326) Of course, in other embodiments, other types of blurring methodology may be used including, but not limited to, a “smearing” of the original image 200 along the direction of motion 300 the generation of “trailers” and/or other streaks indicative of motion, and/or the like.

Referring now to FIG. 4, in one embodiment, the computing device 100 establishes an environment 400 during operation. The illustrative environment 400 includes a scroll processing module 402 to receive and process scrolling signals and a display processing module 404 to control the scrolling of content with motion blur on the display 112. Each of the scroll processing module 402 and the display processing module 404 may be embodied as software, firmware, hardware, or a combination thereof.

The scroll processing module 402 receives input signals relating to the operation of the one or more scrolling devices 114. The illustrative scroll processing module 402 includes one or more sub-modules operable to process one or more scroll input signals received from the scrolling device(s) 114 and produce one or more measured scrolling parameters. In the illustrated embodiment, for example, the scroll processing module 402 includes a scroll distance calculator 410, a scroll direction calculator 412, and a scroll speed calculator 414. Of course, the scroll processing module 402 may include additional or other sub-modules in other embodiments.

The scroll distance calculator 410 is responsive to operation of any of the scrolling devices 114 to determine and produce a scroll distance, SDIS, which is the distance, e.g., in units of lines, pages, files, or other unit of distance measure, in the content currently being displayed via the display 112, through which the user is scrolling. Similarly, the scroll direction calculator 412 is responsive to operation of any of the scrolling devices 114 to determine and produce a scroll direction, SDIR, which is a direction, e.g., up, down, left, right, or diagonal relative to the content currently being displayed, in which the user is scrolling. Additionally, the scroll speed calculator 414 is responsive to the operation of any of the scrolling devices 114 to determine and produce a scroll speed or velocity, SSPD, which is a speed or velocity at which the user is scrolling through the content currently being displayed.

It should be appreciated that each of the respective calculator 410, 412, 414 is operable to compute and produce as an output its associated scrolling parameter, SDIS, SDIR, SSPD, based on the signal or signals produced by one or more of the scrolling device 114. For example, in cases in which scrolling is being controlled via the keypad or keyboard 116, scroll distance, SDIS, scroll direction, SDIR, and scroll speed, SSPD, may be determined in a conventional manner based on the frequency and/or duration that one of the arrow keys, ↑, ↓, →, or ← is depressed. In other cases in which scrolling is being controlled via a mouse, trackball or track pad, for example, the scrolling parameters SDIS, SDIR, and SSPD are determined in a conventional manner based on the frequency and/or duration that a button or bar associated with the mouse, trackball or track pad is depressed, and/or based on a speed and direction which a mouse wheel or trackball is actuated or a track pad is swiped. In still other cases in which scrolling is being controlled via a touch screen-enabled display 112, the scrolling parameters SDIS, SDIR, and SSPD are determined in a conventional manner based on the frequency, duration, and/or direction which the screen is touched or swiped. Those skilled in the art will recognize that other conventional scrolling devices or scroll-enabled devices may be alternatively or additionally implemented, and/or that scrolling may be accomplished with any such device or with any of the devices described herein in a manner alternative to that described herein, and that any such alternative devices and/or scrolling techniques are contemplated by this disclosure.

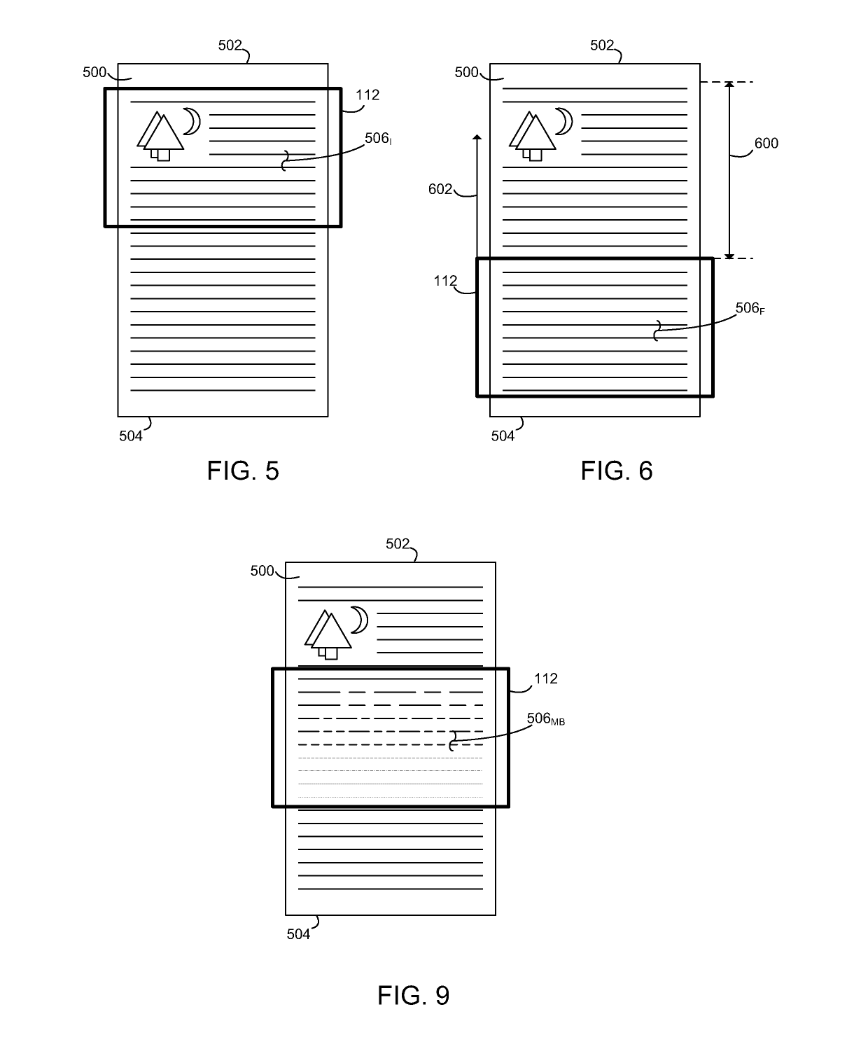

Referring now to FIG. 5 an illustrative embodiment is shown of one portion of content displayed on the display 112 of the computing device 100 during operation. In the embodiment of FIG. 5, the content is illustratively a document 500 having a document top 502 and a document bottom 504 with any number of pages of text and/or graphics, in any page format, between the top 502 and the bottom 504. An outline of the display 112 is shown superimposed over a static initial or beginning portion 506₁ of the document 500 adjacent to the document top 502, illustrating that, because the physical dimensions of the display 112 are fixed and limited, only a limited amount of the content of the document 500 can be statically displayed at any time.

Referring to FIG. 6, the document 500 is shown in which a user has scrolled, using one or more of the scrolling devices 114 described hereinabove, to an end or final portion 506_{F} of the document 500 adjacent to the document bottom 504 such that the display 112 is now superimposed over the end or final portion 506_{F} to signify that the end or final portion 506_{F} of the document 500 is being statically displayed on the display 112. The scrolling distance, SDIS between the examples illustrated in FIGS. 5 and 6 is the scrolling distance 600. Illustratively, the scrolling distance, SDIS, is defined as the distance, e.g., length or width, of displacement of the document 500, or content thereof, relative to the physical dimensions of the display 112, and in the embodiments illustrated in FIGS. 5 and 6, the scrolling distance 500 spans the entire length of the document 500 between the top 502 and bottom 504 thereof. Alternatively, the scrolling distance, SDIS, may be defined as the distance of displacement of one or more of the outer boundaries of the viewing area of the display 112 relative to the document or other content 500. The scrolling direction. SDIR, is illustratively defined as the direction of movement of the document or content 500 relative to the display 112. In the embodiments illustrated in FIGS. 5 and 6, the scrolling direction, SDIR, is upwardly as indicated by the up-arrow 602. Alternatively, the scrolling direction, SDIR, may be defined as the direction of movement of the viewing area of the display 112 relative to the document or content 500, and in the embodiments illustrated in FIGS. 5 and 6, SDIR would, in that embodiment, be in the downward direction opposite the up-arrow 602.

Referring again to FIG. 4, the environment 400 of the computing device 100 may further include a display processing module 404, which is operable to receive as an input or inputs one or more of the measured scrolling parameters determined and produced by the scroll processing module 402, and to control scrolling through content, with motion blur if and when warranted, based on the one or more measured scrolling parameters. In the illustrated embodiment, for example, the display processing module 404 receives as inputs the scroll distance, SDIS, the scroll direction, SDIR, and the scroll speed, SSPD, determined and produced by the scroll processing module 402, and the display processing module 404 is configured in this embodiment to process SDIS, SDIR and SSPD to control scrolling through content, with motion blur if and when warranted, based thereon.

It should be understood that, in other embodiments in which the scroll processing module 402 produces more or fewer such measured scrolling parameters, the display processing module 404 is configured to control content scrolling, with motion blur when and as warranted, based on such more or fewer measured scrolling parameters. As one illustrative embodiment, the scroll processing module 402 may include only the scroll distance calculator 410 and the scroll direction calculator 412. In such an embodiment, the scroll processing module 402 and/or the display processing module 404 may be configured to determine, estimate or otherwise infer the scroll speed, SSPD, as a function of scroll distance, SDIS, over one or more scrolling time periods. In another embodiment, the scroll processing module 402 may include only the scroll direction calculator 412 and the scroll speed calculator 414. In such an embodiment, the scroll processing module 402 or the display processing module 404 may be configured to determine, estimate or otherwise infer the scroll distance, SDIS, as a function of scroll speed, SSPD, over one or more scroll time periods. Of course, other embodiments will occur to those skilled in the art, and any such other embodiments are contemplated by this disclosure.

The display processing module 404 illustratively includes a number of sub-modules which process the scrolling parameters, SDIS, SDIR, and SSPD, to control scrolling through content, with motion blur when and as warranted. In the embodiment illustrated in FIG. 4, for example, the display processing module 404 includes a frame generator 420, a frame buffer 422, a motion blur generator 424, and frame memory 426 (sometimes referred to as a “backing store.”) The frame generator 420 is operable in to generate visual display frames of the content to be displayed on the display 112. The frame memory 426 may be embodied as, or form part of, the memory 108 (and/or memory included in the processor 102 or the graphics processing unit 122).

In the static display illustrated in FIG. 5, for example, the frame generator 420 has generated for visual display a visual frame corresponding to the initial or beginning portion 506_{I} of the document 500, and in the static example illustrated in FIG. 6 the frame generator 420 has generated for visual display a visual frame corresponding to the end or final portion 506_{F} of the document 500. As the content, e.g., the document 500, is moved relative to the viewing portion of the display 112, e.g., via scrolling, the frame generator 420 rapidly generates multiple new visual frames for display. The newly generated frames are stored in the frame buffer 422, and the stored frames are then processed to display an animation on the display 112, which simulates movement of the displayed content. In the embodiment illustrated in FIG. 4, the motion blur generator 424 processes the frames stored in the frame buffer 422 and generates the animation of the moving content in a manner that simulates movement of the content, e.g., the document 500, in the way that humans naturally perceive movement, e.g., blurred, as described hereinabove. In one embodiment, as with motion perceived by humans, the motion blur generator 424 illustratively processes the frames stored in the frame buffer 422 in a manner that causes the display 112 to display the moving animation with the highest clarity possible that is consistent with the settings and capabilities of the display 112 while the speed or velocity of movement of the content is below that which humans normally perceive content blurring, and in a manner that causes the display 112 to display the moving animation with an amount or degree of blurring that is consistent with human perception when the speed or velocity of movement of the content is at or above that which humans normally perceive contenting blurring.

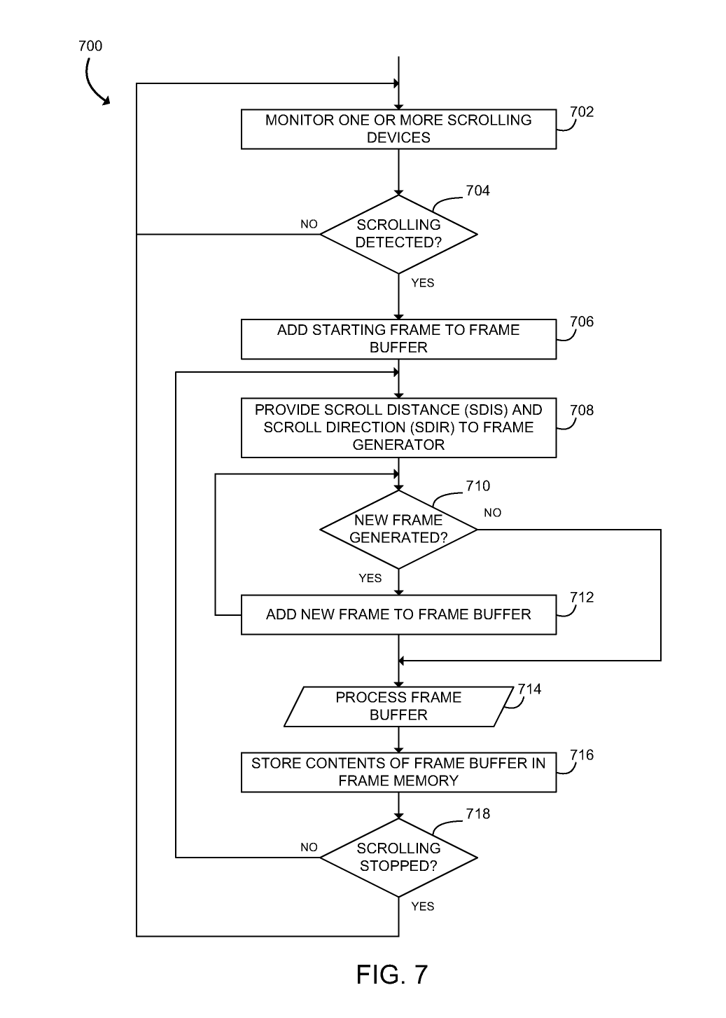

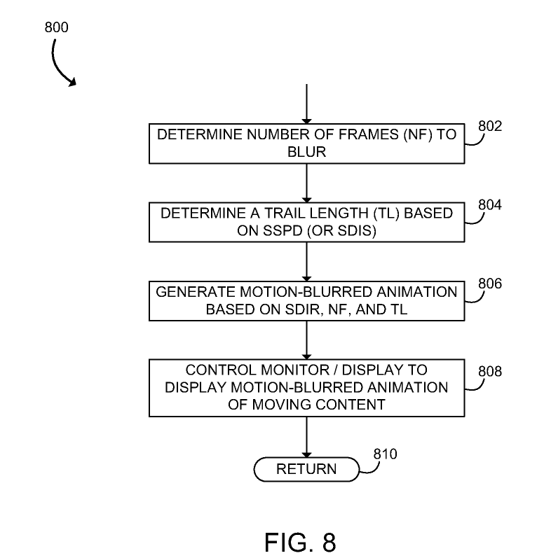

Referring now to FIGS. 7 and 8, simplified flow diagrams are shown of at least one embodiment of a method 700 for scrolling content with motion blur that may be executed by the computing device 100 illustrated in FIG. 1. In one embodiment, the method 700, or portions thereof, may be embodied as one or more sets of instructions stored in the memory 108 (or memory internal to the processor 102 and/or graphics processing unit 122) and executable by the processor 102 and/or graphics processing unit 122. Additionally, in some embodiments, the method 700, or a portion thereof, may be embodied in one or more of the scroll processing module 402 and/or the display processing module 404, which as discussed above may be embodied as software, firmware, hardware, and/or a combination thereof. In any case, the method 700 is executable by the computing device 100 to control scrolling of displayed content with motion blur to simulate content movement in the natural way in which humans perceive motion of objects.

The method 700 begins with block 702 in which the computing device 100 monitors the scrolling device(s) 114 for scrolling activity. In one embodiment, the computing device 100 (e.g., the processor 102, the graphics processing unit 122, or other component or device thereof) is operable at block 702 to monitor all of the scrolling devices 114 connected to and/or integral with the computing device 100 or one of its components. In the embodiment illustrated in FIG. 1, for example, the computing device 100 is operable at block 702 to monitor for scrolling activity or operation of each of the keypad or keyboard 116, any touch screen coupled to or integral with the display 112, or any other peripheral scrolling device 114. In other embodiments, the computing device 100 may be operable at block 702 to monitor fewer, e.g., a selected one or selected ones, of the scrolling devices 114. If no scrolling activity (i.e., activation/operation of one or more of the scrolling devices 114) is detected in block 704, the method 700 loops back to block 702 to continue monitoring for scrolling activity. If, however, the computing device 100 detects scrolling activity, the method 700 advances to block 706.

In block 706, in response to detecting a scrolling activity, the computing device 100 adds the starting frame, i.e., the frame being displayed on the display 112 at the time scrolling began, to the frame buffer 422. In block 708, the scroll distance, SDIS, and scroll direction, SDIR, produced by the scroll distance calculator 410 and the scroll direction calculator 412 respectively, are provided to the frame generator 420. In other embodiments described hereinabove in which the scroll distance calculator 410 is omitted, the scroll processing module 402 or the display processing module 404 may include a conversion block operable to produce the scroll distance, SDIS, as a function of the scroll speed, SSPD, and time. In any case, the method 700 advances to block 710 in which the computing device 100 determines whether a new frame has been generated (i.e., whether the frame generator 420 has generated a new frame as a result of the detected scrolling operation/activity). If no new frame is generated, the method 700 advances to block 714 in which the frame buffer 422 is processed as discussed in more detail below with regard to method 800 illustrated in FIG. 8. However, if a new frame has been generated, the method 700 advances to block 712 in which the newly generated frame is added to the frame buffer 422. The method 700 subsequently loops back to block 710 in which the generation of additional new frames is detected. Additionally, the method 700 advances to block 714 in which the frame buffer 422 is processed. In this way, the method 700 continues to add new frames to the frame buffer 422 contemporaneously with the processing of the frame buffer 422.

Following execution of the frame buffer processing routine in block 714, the method 700 advances to block 716 in which the computing device 100 stores the contents of the frame buffer 422 in the frame memory 426. Thereafter, in block 718, the computing device 100 determines whether the scrolling activity/operation has stopped, for example, by determining that the scroll distance, SDIS, and/or scroll speed, SSPD, is less than or equal to a threshold value. If not, the method 700 loops back to block 708 in which the scrolling parameters are produced and provided to the frame generator 420. If, however, the computing device 100 determines that the scrolling activity/operation has stopped in block 718, the method 700 loops back to block 702 to continue monitoring the scrolling device(s) 114.

Referring now to FIG. 8, a simplified flow diagram is shown of at least one embodiment of the frame buffer processing method 800 that may be executed in the block 714 of FIG. 7. In the illustrative embodiment, the frame buffer processing method 800 buffer process routine begins with block 802 in which the computing device 100 (e.g., the motion blur generator 424) determines or selects the number of frames (NF) to blur. The computing device 100 illustratively has an associated maximum number of frames per second (MFPS), which is generally the maximum number of frames that the computing device 100 is capable of processing per second, and MPFS may be different for different embodiments of the computing device 100. In one embodiment, the number of frames, NF, is selected to be a fraction of MFPS, and one example formula for calculating the number of frames, NF, at block 802, may be of the form NF=MFPS*0.1*C1. In such embodiments, C1 is illustratively a constant that may be modified to provide for some amount of fine adjustment of NF, in which case NF is a static or constant value, although C1 may alternatively be a dynamic value that may be a function, for example, of one or more of SDIS, SSPD or other measure of scrolling activity/operation. In other embodiments of block 802, the number of frames, NF, may be a static value computed according to other formulae and/or criteria, or may instead be a dynamic variable that changes as a function of scroll speed, SSPD, scroll distance, SDIS, or other measure of scrolling activity/operation.

In any case, the method 800 advances to block 804 in which the computing device 100 (e.g., the motion blur generator 424) determines a blur trail having a tail length, it is generally understood that human vision systems have a physiological characteristic sometimes referred to as “persistence of vision” in which moving objects appear to be periodically frozen, or stopped, for a fraction of a second, e.g., for approximately 0.1 seconds, as they travel through space. This is because the human vision system cannot keep up with, i.e., track, fast moving objects, and the human vision system compensate for this by periodically sampling the moving object. It is this phenomenon that causes humans to perceive fast-moving objects as being blurred in their direction of their movement, and this phenomenon is manifested in human vision systems as a blur trail, i.e., a blurred and somewhat distorted trail of objects in a direction opposite to their direction of movement. A similar effect occurs in photography when shooting photos in low ambient light. In any case, the motion blur generator 424 is illustratively operable at block 804 to compute the length, LT, of this blur trail of the moving content as a function of scroll speed, SSPD. In one embodiment, the motion blur generator 424 is operable at block 804 to compute the trail length, LT, according to an equation of the form LT=SSPD*0.1 (sec)*C2 such that LT is a dynamic function of SSPD. In such embodiment, C2 is illustratively a constant that may be modified to provide for some amount of fine adjustment of LT, although C2 may alternatively be a dynamic value that may be a function, for example, of one or more of SDIS, SSPD or other measure of scrolling activity/operation. In other embodiments of block 804, the scroll speed, SSPD can be determined or estimated as a function of scroll distance. In such embodiments, either the scroll processing module 402 or the display processing module 404 may determine or estimate SSPD based on SDIS. Additionally, in such embodiments, the scroll speed calculator 414 may be omitted. It should be appreciated that, although block 802 and 804 are illustrated in FIG. 8 in a sequential order, the blocks 802, 804 may be executed in any order or contemporaneously with each other in some embodiments.

After the number of frames (NF) and the trail length (TL) has been determined in block 804, the method 800 advances to block 806 in which the computing device 100 (e.g., the motion blur generator 424) generates a motion-blurred animation of the moving content based on the number of frames (NF) computed in block 802, the tail length (TL) computed in block 804, and the scroll direction, SDIR, provided by the scroll processing module 402. The scroll direction, SDIR, is illustratively used by the motion blur generator 424 to determine direction of movement of the displayable content relative to the display 112; the number of frames (NF) is illustratively used by the motion blur generator 424 to set the frames per second (FPS) rate of display of the animation, and the trail length (TL) is illustratively used by the motion blur generator 424 to blur the animation in the direction of motion of the moving content by appending or blending a blurred trail behind the moving content with a trail length (TL).

Subsequently, hr block 808, the computing device 100 displays the motion-blurred animation of the moving content as the content is being scrolled on the display 112. The method 800 may subsequently return to its calling routine in block 810.

Referring now to FIG. 7, the example content, e.g., document 500, illustrated in FIGS. 5 and 6 is shown with the viewing area of the display 112 superimposed over a middle portion 506_{MB} of the document 500. The FIG. 7 is intended to depict a snapshot of the middle portion 506_{MB} during scrolling of the document 500 in the upward direction, e.g., in the direction 602 shown in FIG. 6, relative to the viewing area of the display 112 using the methods 700, 800 illustrated in, and discussed above with regard to, FIGS. 7 and 8. The content in the middle portion 506_{MB} is depicted with gradually finer dashed lines to simulate motion blur in the direction 502 of movement of the document 500 relative to the viewing area of the display 112.

Motion blur of moving animation resulting from scrolling through displayable content has been disclosed herein in the context of a system-wide or device-wide application and, as such, is intended to be available to any application that may be executed by the processor 102 of the computing device 100 in a manner that results in content which can be scrolled through in any direction, e.g., up, down, left, right, or diagonally. Alternatively, this technique may be available only to one or more selected applications executed by the processor 102.

### EXAMPLES

Illustrative examples of the devices, systems, and methods disclosed herein are provided below. An embodiment of the devices, systems, and methods may include any one or more, and any combination of, the examples described below.

In one example, a computing device for scrolling through displayable content may include a display to display the displayable content, at least one scrolling device operable by a user of the computing device to scroll the displayable content, a scroll processing module, and a display processing module. The scroll processing module may produce a scroll direction and at least one of a scroll distance and a scroll speed, corresponding to a direction of movement, a measure of displacement, and a velocity of movement, respectively, of the displayable content relative to the display resulting from operation of the at least one scrolling device. The display processing module may generate for display on the display a motion blurred animation of movement of the displayable content resulting from operation of the at least one scrolling device based on the scroll direction and the at least one of the scroll distance and the scroll speed.

In an example, the computing device may further include a processor configured to control the display to display the motion blurred animation of movement of the displayable content resulting from operation of the at least one scrolling device or scroll-enabled device. In an example, the scroll processing module may include a scroll direction calculator to produce the scroll direction based on one or more signals provided by the at least one scrolling device. In an example, the scroll processing module may, additionally or alternatively, include a scroll distance calculator to produce the scroll distance based on one or more signals provided by the at least one scrolling device. In an example, the display processing module may include a frame generator to produce visual frames of the displayable content, a frame buffer to store the visual frames produced by the frame generator, and a motion blur generator to determine a number of the stored visual frames to blur, a tail length of blur based on the scroll distance. The motion blur generator may generate the motion blurred animation of movement of the displayable content relative to the display based on the number of the stored visual frames to blur, the tail length of blur and the scroll direction. In an example, the motion blur generator may determine the tail length of blur according to the following equation: LT=SSPD*0.1*C2, wherein LT is the tail length, SSPD is the scroll speed, and C2 is a constant. In an example, the motion blur generator may determine the number of visual frames to blur according to the following equation: NF=MPFS*0.1*C1, wherein NF is the number of visual frames to blur, MPFS is the maximum number of frames displayable by the display, and C1 is a constant.

In an example, the scroll processing module may include a scroll speed calculator to produce the scroll speed based on one or more signals provided by the at least one scrolling device. In such an example, the display processing module may include a frame generator to produce visual frames of the displayable content, a frame buffer to store the visual frames produced by the frame generator, and a motion blur generator to determine a number of the stored visual frames to blur, a tail length of blur based on the scroll speed. In an example, the motion blurred animation of movement of the displayable content relative to the display based on the number of the stored visual frames to blur, the tail length of blur and the scroll direction. In an example, the motion blur generator may determine the number of visual frames to blur according to the following equation: NF=MPFS*0.1*C1, wherein NF is the number of visual frames to blur, MPFS is the maximum number of frames displayable by the display, and C1 is a constant. In an example, the motion blur generator is to determine the tail length of blur according to the following equation: LT=SSPD*0.1*C2, wherein LT is the tail length, SSPD is the scroll speed, and C2 is a constant.

In an example, each of the scroll processing module and the display processing module may form part of a graphics processing unit of the computing device. In an example, the display processing module may accumulate historic frames of the displayable content and display each of the historic frames contemporaneously with each other to produce the motion blurred animation of movement of the displayable content. In an example, the display may include a touch screen display and the at least one scrolling device comprises a touch screen of the touch screen display. In an example, the displayable content is text or a graphic.

In another example, a method of scrolling through displayable content on a display of a computing device may include monitoring a scrolling device of the computing device; and in response to detecting scrolling of the displayable content by the scrolling device, (i) determining a scroll direction and at least one of a scroll distance and a scroll speed based on signals produced by the scrolling device during scrolling of the displayable content and (ii) generating a motion blurred animation of movement of the displayable content resulting from scrolling of the displayable content by the scrolling device based on the scroll direction and the at least one of the scroll distance and the scroll speed. In an example, the method may further include controlling the display to display the motion blurred animation of movement of the displayable content resulting from operation of the scrolling device.

In an example, generating a motion blurred animation of movement of the displayable content may include producing a sequence of visual frames of the displayable content as the displayable content is scrolled by the scrolling device, storing each visual frame in the sequence of visual frames in a memory, determining a number of the stored visual frames to blur, determining a tail length of blur based on the scroll distance, and generating the motion blurred animation of movement of the displayable content relative to the display based on the number of the stored visual frames to blur, the tail length of blur and the scroll direction. In an example, determining the number of the stored visual frames to blur comprises determining the number of the stored visual frames to blur according to the following equation: NF=MPFS*0.1*C1, wherein NE is the number of visual frames to blur, MPFS is the maximum number of frames displayable by the display, and C1 is a constant. In an example, determining the tail length of blur comprises determining the tail length of blur according to the following equation: LT=SSPD*0.1*C2, wherein LT is the tail length, SSPD is the scroll speed, and C2 is a constant.

In an example, generating the motion blurred animation of movement of the displayable content may include generating, on a graphics processing unit of the computing device, a motion blurred animation of movement of the displayable content resulting from scrolling of the displayable content by the scrolling device based on the scroll direction and the at least one of the scroll distance and the scroll speed. In an example, the displayable content comprises at least one of text and graphical images.

In another example, a computing device may include a processor and a memory having stored therein a plurality of instructions that, in response to being executed by the processor, results in the processor performing any of the methods described above. Additionally, in another example, one or more machine-readable storage medium comprising a plurality of instructions stored thereon that, in response to being executed, result in a computing device performing any of the methods described above.

In an example, a mobile computing device for scrolling through displayable content may include a display to display the displayable content; a scrolling device operable by a user of the computing device to scroll the displayable content on the display; and a display processing module to, during the scrolling of the display content, (i) accumulate historic frames of the displayable content and (ii) display each of the historic frames contemporaneously with each other on the display to produce a motion blurred image of the displayable content in response to the operation of the scrolling device. In an example, the display may include a touch screen display and the scrolling device comprises a touch screen of the touch screen display.

While the concepts of the present disclosure have been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

1-26. (canceled)

27. A computing device for scrolling through displayable content, comprising:
a display to display the displayable content;
at least one scrolling device operable by a user of the computing device to scroll the displayable content;
a scroll processing module to produce a scroll direction and at least one of a scroll distance and a scroll speed, corresponding to a direction of movement, a measure of displacement, and a velocity of movement, respectively, of the displayable content relative to the display resulting from operation of the at least one scrolling device, and
a display processing module to generate for display on the display a motion blurred animation of movement of the displayable content resulting from operation of the at least one scrolling device based on the scroll direction and the at least one of the scroll distance and the scroll speed.

28. The computing device of claim 27 further comprising a processor configured to control the display to display the motion blurred animation of movement of the displayable content resulting from operation of the at least one scrolling device or scroll-enabled device.

29. The computing device of claim 27 wherein the scroll processing module comprises a scroll direction calculator to produce the scroll direction based on one or more signals provided by the at least one scrolling device.

30. The computing device of claim 27 wherein the scroll processing module comprises a scroll distance calculator to produce the scroll distance based on one or more signals provided by the at least one scrolling device.

31. The computing device of claim 30 wherein the display processing module comprises:
a frame generator to produce visual frames of the displayable content,
a frame buffer to store the visual frames produced by the frame generator, and
a motion blur generator to determine a number of the stored visual frames to blur, a tail length of blur based on the scroll distance, and to generate the motion blurred animation of movement of the displayable content relative to the display based on the number of the stored visual frames to blur, the tail length of blur and the scroll direction.

32. The computing device of claim 27, wherein the scroll processing module comprises a scroll speed calculator to produce the scroll speed based on one or more signals provided by the at least one scrolling device.

33. The computing device of claim 32 wherein the display processing module comprises:
a frame generator to produce visual frames of the displayable content,
a frame buffer to store the visual frames produced by the frame generator, and
a motion blur generator to determine a number of the stored visual frames to blur, a tail length of blur based on the scroll speed, and to generate the motion blurred animation of movement of the displayable content relative to the display based on the number of the stored visual frames to blur, the tail length of blur and the scroll direction.

34. The computing device of claim 27, wherein each of the scroll processing module and the display processing module form part of a graphics processing unit of the computing device.

35. The computing device of claim 27, wherein the display processing module accumulate historic frames of the displayable content and displays each of the historic frames contemporaneously with each other to produce the motion blurred animation of movement of the displayable content.

36. The computing device of claim 27, wherein the display comprises a touch screen display and the at least one scrolling device comprises a touch screen of the touch screen display.

37. The computing device of claim 27, wherein the displayable content is text or a graphic.

38. A method of scrolling through displayable content on a display of a computing device, the method comprising:
monitoring a scrolling device of the computing device; and
in response to detecting scrolling of the displayable content by the scrolling device, (i) determining a scroll direction and at least one of a scroll distance and a scroll speed based on signals produced by the scrolling device during scrolling of the displayable content and (ii) generating a motion blurred animation of movement of the displayable content resulting from scrolling of the displayable content by the scrolling device based on the scroll direction and the at least one of the scroll distance and the scroll speed.

39. The method of claim 38, further comprising controlling the display to display the motion blurred animation of movement of the displayable content resulting from operation of the scrolling device.

40. The method of claim 38 wherein generating a motion blurred animation of movement of the displayable content comprises:
producing a sequence of visual frames of the displayable content as the displayable content is scrolled by the scrolling device,
storing each visual frame in the sequence of visual frames in a memory,
determining a number of the stored visual frames to blur,
determining a tail length of blur based on the scroll distance, and
generating the motion blurred animation of movement of the displayable content relative to the display based on the number of the stored visual frames to blur, the tail length of blur and the scroll direction.

41. The method of claim 40, wherein generating the motion blurred animation of movement of the displayable content comprises generating, on a graphics processing unit of the computing device, a motion blurred animation of movement of the displayable content resulting from scrolling of the displayable content by the scrolling device based on the scroll direction and the at least one of the scroll distance and the scroll speed.

42. One or more machine-readable storage medium comprising a plurality of instructions stored thereon that, in response to being executed, result in a computing device:
monitoring a scrolling device of the computing device; and
in response to detecting scrolling of the displayable content by the scrolling device, (i) determining a scroll direction and at least one of a scroll distance and a scroll speed based on signals produced by the scrolling device during scrolling of the displayable content and (ii) generating a motion blurred animation of movement of the displayable content resulting from scrolling of the displayable content by the scrolling device based on the scroll direction and the at least one of the scroll distance and the scroll speed.

43. The one or more machine-readable storage medium of claim 42, wherein the plurality of instructions further result in the computing device controlling the display to display the motion blurred animation of movement of the displayable content resulting from operation of the scrolling device.

44. The one or more machine-readable storage medium of claim 42, wherein the plurality of instructions result in the computing device generating the motion blurred animation of movement of the displayable content by:
producing a sequence of visual frames of the displayable content as the displayable content is scrolled by the scrolling device,
storing each visual frame in the sequence of visual frames in a memory,
determining a number of the stored visual frames to blur,
determining a tail length of blur based on the scroll distance, and
generating the motion blurred animation of movement of the displayable content relative to the display based on the number of the stored visual frames to blur, the tail length of blur and the scroll direction.

45. The one or more machine-readable storage medium of claim 42, wherein the plurality of instructions result in the computing device generating the motion blurred animation of movement of the displayable content by generating, on a graphics processing unit of the computing device, a motion blurred animation of movement of the displayable content resulting from scrolling of the displayable content by the scrolling device based on the scroll direction and the at least one of the scroll distance and the scroll speed.

46. A mobile computing device for scrolling through displayable content, comprising:
a display to display the displayable content;
a scrolling device operable by a user of the computing device to scroll the displayable content on the display; and
a display processing module to, during the scrolling of the display content, (i) accumulate historic frames of the displayable content and (ii) display each of the historic frames contemporaneously with each other on the display to produce a motion blurred image of the displayable content in response to the operation of the scrolling device.

47. The mobile computing device of claim 46, wherein the display comprises a touch screen display and the scrolling device comprises a touch screen of the touch screen display.
